(19) United States
(12) Patent Application Publication
(10) Pub. No.: US 2003/0158810 A1
(43) Pub. Date: Aug. 21, 2003

(54) Method, system, and apparatus for open services architecture

(76) Inventor: Naiem Dathi, San Francisco, CA (US)

Correspondence Address: HEWLETT-PACKARD COMPANY, Intellectual Property Administration, P. O. Box 272400, Fort Collins, CO, 80527-2400, US

(21) Appl. No.: 10/345,159

(22) Filed: Jan. 15, 2003

Related U.S. Application Data
(63) Continuation of application No. 09/429,855, filed on Oct. 28, 1999.

(51) Int. Cl. G06F 17/60

(52) U.S. Cl. 705/37

(57) ABSTRACT

A method, system, and apparatus for creating an open services module that operates in a computer system to novelly form and manage a contract for open services in a computer-based electronic commerce environment. An open service is a meaningful set of capabilities that may be freely offered in a computer-based environment by a buyer or a seller. The open service may be performed in exchange for value and the functionality of the open service may be described, including the value of the open service per each associated transaction. The present embodiment novelly introduces electronic business transaction phases that distinguish between offer creation, offer advertising and discovery, pre-contractual negotiation, contract formation, and contract performance. By novelly introducing electronic business transaction phases to the operation of creating and managing an open service contract, the present embodiment enables a distributed computing solution for the exchange of valuable services in which a party may assume a variety of roles.

### RELATED APPLICATION

The following application is related to the present application. U.S. patent application entitled “METHOD, SYSTEM, AND APPARATUS FOR EXECUTING OPEN SERVICES,” attorney docket number 10992405-1, naming as inventor Naiem Dathi, assigned to the assignee of the present invention and filed concurrently herewith, the detailed description and figures of which are incorporated by reference in their entirety as specified in the specification of the present invention.

### FIELD OF THE INVENTION

The present invention relates generally to a method, system, and apparatus for creating and managing a contract for open services in a computer-based electronic commerce environment.

### BACKGROUND OF THE INVENTION

Typically, conducting business transactions that exchange services for value in computer-based electronic environments, such as the internet, has been limited due to the lack of distinction between the phases of conducting electronic business. By means of example, a party may operate as a broker or advertiser for a service while not participating in the formation of the contract for services. Further, the computer-based support required for electronic business transactions is not necessarily the same at every phase of the transaction. For example, computer-based support that manages authorization of parties to participate in a contract performance phase may be different than the management of authorization of parties participating in activities occurring prior to performance of a computer-based contract. Therefore, it would be advantageous to operate electronic business transactions that enable distinctions between the phases of an electronic business transaction.

Also, conducting business transactions that exchange services for value in a computer-based electronic environment, such as the internet, has been limited due to the lack of adequate mechanisms that ensure contract performance. That is, computer-based business transactions have not been supported by a trustworthy electronic business transaction system that ensures adequate enforcement of contract performance.

Distributed computing combines a number of individual computer-based components to create a view of a shared computer-based component. This can be accomplished by use of computer hardware, software, or a combination of computer hardware and software. More particularly, distributed computing typically operates with loosely coupled computer systems that operate on independent tasks and that transmit information about tasks operating on each computer system. An example of distributed computing is a client-server computer solution.

Typically client-server computer solutions operate with computer applications that have a distinct role associated with either a client or a server. The server typically defines the type of services that can be offered and the client typically operates to request services from the server. Therefore, typically a client is a buyer and a server is a seller in an electronic business transaction. Computer-based support for creating and managing a service contract has limited the role of parties to a client-buyer role and a server-seller role, which has resulted in electronic business transaction solutions that limit the roles of participating parties. That is, conducting complex business transactions in a computer-based electronic environment has been limited due to inflexible buyer and seller roles that do not accommodate fluid electronic business interactions, such as the internet, in which a participant may need to operate as both a buyer and a seller. It would be advantageous if a party to a computer-based electronic business transaction could operate to form and manage a service contract without being limited to either a buyer role or a seller role.

### SUMMARY OF THE INVENTION

The present invention is a method, system, and apparatus for creating and managing a contract for open services in a computer-based electronic commerce environment.

The present embodiment novelly enables parties to form and manage a contract for open services without limiting each party to a buyer role or a seller role. The term “service” as used herein represents a meaningful set of capabilities that may be offered for economic interaction. The phrase “open service” as used herein represents a service freely offered in a computer-based electronic environment. The open service offer is based on trust that performance associated with an open service contract will be monitored and enforced by a trusted third party. Further, the open service may be performed in exchange for value and the terms and conditions of the open service contract may be described, including the value of the open service per each associated transaction.

The present embodiment novelly enables computer system users associated with the open service to assume a variety of roles. For instance a mediator role transacts pre-contractual negotiations and forms an offer. A buyer-seller role performs an open service that is associated with an open service contract. A market maker role monitors the performance and enforces the agreement associated with an open service contract. A buying-selling agency role advantageously operates on an economy of scale to combine open service offers and decompose open service offers that enable prospective open service participants to access alternatively packaged open service offers.

The present embodiment creates an open service that is a meaningful set of capabilities that may be offered in an economic transaction that takes place in a free market economy. That is, an open service may be offered, may be the subject of a contract, and may be managed. More particularly an open service may be offered since the associated capability may be described and the economic value associated with its use may be described. An open service may be the subject of a contract since it may be offered for value. Also, an open service may be managed since an associated open service description may describe both the open service functionality and the management policies, including billing.

The phrase “free market economy” as used herein is the minimal societal infrastructure necessary to carry out business transactions and includes a trustworthy electronic business transaction system that ensures adequate enforcement of contract performance. A trusted third party, such as a marketmaker, supports the free market economy infrastructure associated with an open service by enabling computer-based network communication and security, managing levels of authorization privileges associated with a citizen, and enforcing performance of an open service contract. It will be appreciated that other forms of market economy may be represented as subsets of a free market economy since a free market economy is the minimal infrastructure necessary to carry out business transactions. A free market maintains minimal constraints on business transactions and therefore the present embodiment that operates in a free market economy enables parties to provide the maximum level of open services.

Further, the present embodiment introduces electronic business transaction phases that distinguish between offer creation, offer advertising and discovery, pre-contractual negotiation, contract formation, and contract performance. Therefore, by novelly introducing phases to the operation of creating and managing an open service contract, the present embodiment enables a distributed computing solution for the exchange of valuable open services in which a participant may assume a variety of roles. For example, the present embodiment novelly enables an open service that may be negotiated by multiple parties, and the same party may respond to the open service offer or may change the open service offer. A phase is typically an element of a lifecycle and phases operate in a specified order. The phrase “electronic business transaction phases” as used herein represents lifecycle phases that are elements of the process of creating and managing an electronic contract for open services.

Other aspects and advantages of the present invention will become apparent from the following detailed description, taken in conjunction with the accompanying drawings, illustrating by way of example the principles of the invention.

### BRIEF DESCRIPTION OF THE DRAWINGS

The accompanying drawings are incorporated in and constitute a part of this specification and, together with the description, explain the advantages and principles of the invention. In the drawings,

FIG. 1A is a block diagram that illustrates an open services module that operates in a computer system;

FIG. 1B is a block diagram that illustrates a compiler technology that operates in cooperation with the open services module;

FIG. 1C is a block diagram that illustrates the operation of the open services module in coordination with an emulator;

FIG. 2 illustrates data structures and modules used by the open services module that may be stored in the memory;

FIG. 3 is a flow diagram that illustrates the operation of the open services module throughout the electronic business transaction phases;

FIG. 4 is a flow diagram that illustrates the enterprise role of the present embodiment;

FIG. 5A is a flow diagram that illustrates the marketmaker tool and the citizen tool operation;

FIG. 5B is a flow diagram that illustrates the buyer-seller tool operation;

FIG. 5C is a flow diagram that illustrates the operation of the marketmaker tool and the buyer-seller tool during the contract performance phase;

FIG. 5D is a flow diagram that illustrates the mediator tool operation; and

FIG. 5E is a flow diagram that illustrates the buying-selling agency tool operation.

### DETAILED DESCRIPTION

In the following detailed description and in the several figures of the drawings, like elements are identified with like reference numerals.

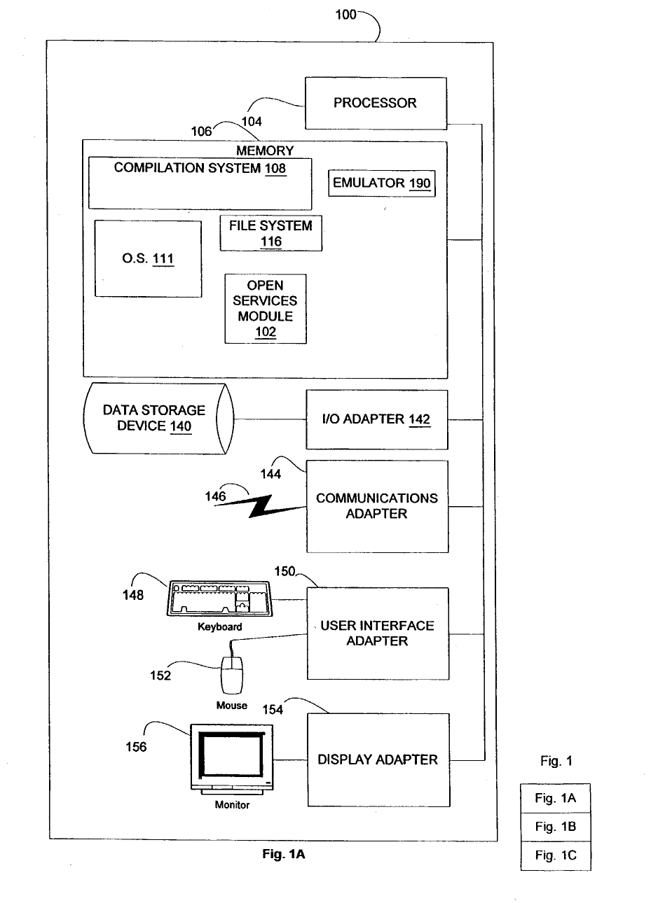

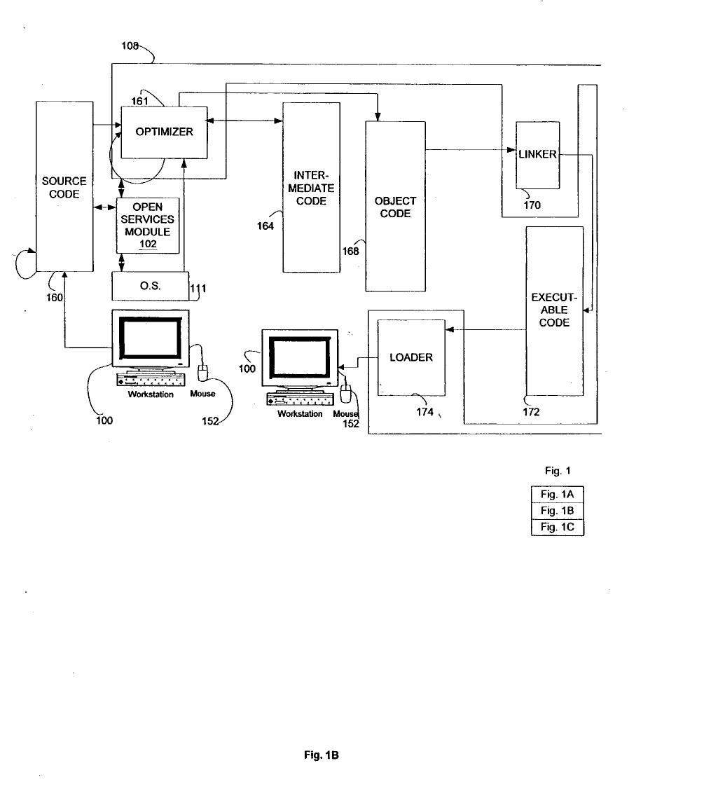

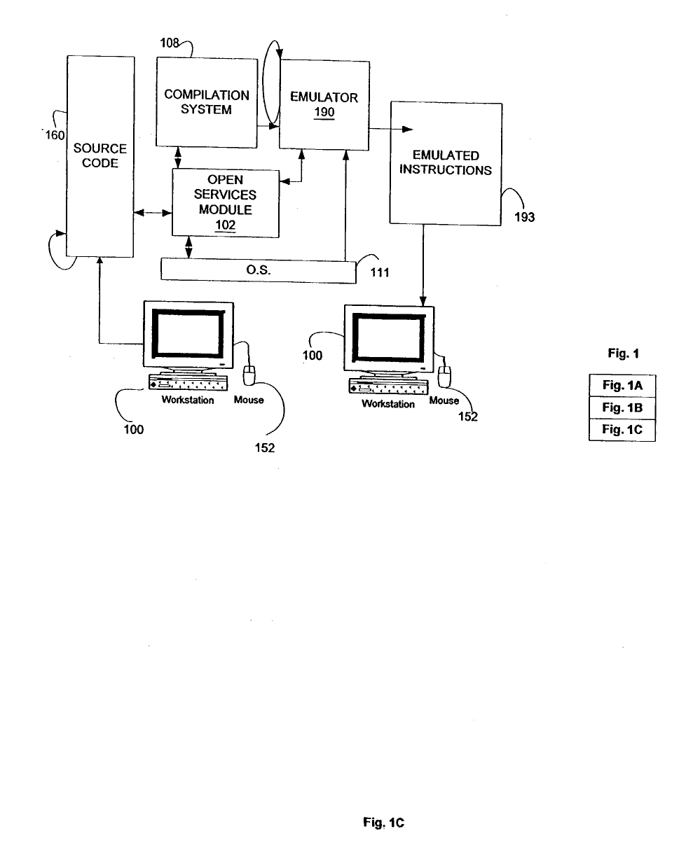

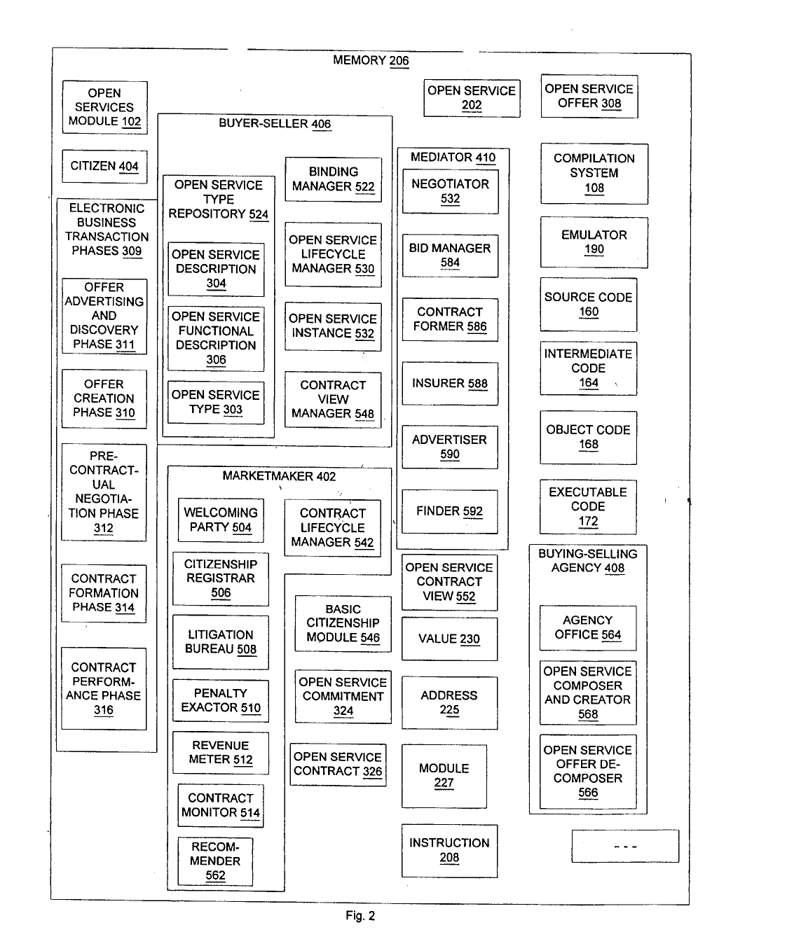

Broadly stated, FIG. 1A illustrates an open services module 102 that operates in a computer system 100 to novelly form and manage a contract for open services 202 (as shown in FIG. 2) in a computer-based electronic commerce environment. An open service 202 is a meaningful set of capabilities that may be freely offered in a computer-based environment by a buyer or a seller. The open service 202 may be performed in exchange for value and the functionality of the open service 202 may be described, including the value of the open service 202 per each associated transaction. The present embodiment novelly introduces electronic business transaction phases 309 (as shown in FIG. 2) that distinguish between offer creation 310, offer advertising and discovery 311, pre-contractual negotiation 312, contract formation 314, and contract performance 316 (as are shown in FIG. 2). By novelly introducing electronic business transaction phases 309 to the operation of creating and managing an open service contract 326, the present embodiment enables a distributed computing solution for the exchange of valuable services in which a party may assume a variety of roles.

FIG. 1A further represents the computer system 100 that includes components such as a processor 104, the memory 106, a data storage device 140, an input/output (I/O) adapter 142, a communications adapter 144, a communications network 146, a user interface adapter 150, a keyboard 148, a mouse 152, a display adapter 154, and a computer monitor 156. It will be understood by those skilled in the relevant art that there are many possible configurations of the components of the computer system 100 and that some components that may typically be included in the computer system 100 are not shown.

It will be understood by those skilled in the art that the functions ascribed to the open services module 102, or any of its functional files, typically are performed by a central processing unit that is embodied in FIG. 1A as the processor 104 executing such software instructions 208.

The processor 104 typically operates in cooperation with software programs such as the compilation system 108, the operating system (O.S.) 111, and the open services module 102. Henceforth, the fact of such cooperation among the processor 104 and the open services module 102, whether implemented in software, hardware, firmware, or any combination thereof, may therefore not be repeated or further described, but will be implied. The open services module 102 typically operates in cooperation with the emulator 109 and the compilation system 108 but is not limited to such operation. For example the open services module 102 may operate in cooperation with the O.S. 111.

The O.S. 111 may cooperate with a file system 116 that manages the storage and access to files within the computer system 100. Files typically include instructions 208 and data. The interaction between the file system 116 and the O.S. 111 will be appreciated by those skilled in the art.

It will also be understood by those skilled in the relevant art that the functions ascribed to the open services module 102 and its functional files, whether implemented in software, hardware, firmware, or any combination thereof, may in some embodiments be included in the functions of the O.S. 111. That is, the O.S. 111 may include files from the open services module 102. In such embodiments, the functions ascribed to the open services module 102 typically are performed by the processor 104 executing such software instructions 208 in cooperation with aspects of the O.S. 111 that incorporate the open services module 102. Therefore, in such embodiments, cooperation by the open services module 102 with aspects of the O.S. 111 will not be stated, but will be understood to be implied.

The open services module 102 may be embodied in any computer-readable medium for use by or in connection with an instruction execution system, apparatus, or device, such as a computer system 100 or other system that can fetch the instructions 208. In the context of this document, a “computer-readable medium” can be any medium that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, propagation medium, or computer memory 106.

Computer memory 106 may be any of a variety of known memory storage devices or future memory devices, including any commonly available random access memory (RAM), cache memory, magnetic medium such as a resident hard disk, or other memory storage devices. In one embodiment the O.S. 111 and the open services module 102 may reside in the memory 106 during execution in the computer system 100. The term “storage” refers herein to computer resources such as memory 106, and may be used to store data or instructions 208 used in executing a computer program.

The compilation system 108 and the O.S. 111 may also reside in the memory 106 when the open services module 102 is operating. Further, the compilation system 108 may operate in cooperation with the O.S. 111 to execute the open services module 102. That is, the present embodiment may employ the compilation system 108 to resolve any system-specific information such as address 225 locations that are necessary to execute the open services module 102 in the computer system 100.

The open services module 102 includes instructions 208 (as shown in FIG. 2) and data that may be referred to as “values” 230 such as integer, real, or complex numbers; or characters. Alternatively, the values 230 may be pointers that reference values 230 (as shown in FIG. 2). Therefore, a pointer provides direction to locate a referenced value 230. For instance, an instruction 208 may represent a computer address 225 (as shown in FIG. 2) that may be a computer hardware register or a location in the memory 106. Instructions 208 may also include variables that are identifiers for values 230. That is, the variables may provide storage for values 230.

It will be appreciated that the term “execute” refers herein to the process of manipulating code, such as software or firmware instructions 208, for operation on the computer system 100. The term “code” refers to instructions 208 or data used by the computer system 100 for the purpose of generating instructions 208 or data that execute in the computer system 100. Also, the term “module” 227 (as shown in FIG. 2) may refer to a software “procedure” or “function” such as a unit of code that may be independently compiled. A “program” contains software program code, may contain at least one module 227, and may be independently compiled and executed.

It will be appreciated that an emulator 190 may be included in the computer system 100. The emulator 190 substitutes instructions 208 typically associated with a different computer system 100 than the executing computer system 100, for the original instructions 208. It will be appreciated that the substituted instructions 208 may be associated with a hardware, software, or firmware representation of a different computer system 100. The cooperation of the open services module 102 and the emulator 190 is discussed with reference to FIG. 1C.

The open services module 102 may be implemented in the programming language marketed under the trademark JAVA,™ although it will be understood by those skilled in the relevant art that other programming languages could be used. Also, the open services module 102 may be implemented in any combination of software, hardware, or firmware.

The data storage device 140 may be any of a variety of known or future devices, including a compact disk drive, a tape drive, a removable hard disk drive, or a diskette drive. Any such program storage device may communicate with the I/O adapter 142, that in turn communicates with other components in the computer system 100, to retrieve and store data used by the computer system 100. As will be appreciated, such program storage devices typically include a computer usable storage medium having stored therein a computer software program and data.

Input devices may include any of a variety of known I/O devices for accepting information from a user, whether a human or a machine, whether local or remote. Such devices include, for example a keyboard 148, a mouse 152, a touch-screen display, a touch pad, a microphone with a voice recognition device, a network card, or a modem. The input devices may communicate with a user interface I/O adapter 142 that in turn communicates with components in the computer system 100 to process I/O commands. Output devices could include any of a variety of known I/O devices for presenting information to a user, whether a human or a machine, whether local or remote. Such devices include, for example, the computer monitor 156, a printer, an audio speaker with a voice synthesis device, a network card, or a modem. Output devices such as the monitor 156 may communicate with the components in the computer system 100 through the display adapter 154. Input/output devices could also include any of a variety of known data storage devices 140 including a compact disk drive, a tape drive, a removable hard disk drive, or a diskette drive.

By way of illustration, program code may typically be loaded through an input device and may be stored on the data storage device 140. A copy of the code or portions of it, may alternatively be placed by the processor 104 into the memory 106 for execution on the computer system 100.

The computer system 100 may communicate with the network 146 through a communications adapter 144, such as a networking card. The network 146 may be a local area network, a wide area network, or another known computer network or future computer network. It will be appreciated that the I/O device used by the open services module 102 may be connected to the network 146 through the communications adapter 146 and therefore may not be co-located with the computer system 100. It will be further appreciated that other portions of the computer system 100, such as the data storage device 140 and the monitor 156, may be connected to the network 146 through the communications adapter 144 and may not be co-located.

FIG. 1B is a block diagram that illustrates a compiler technology 108 that operates in cooperation with the open services module 102. The open services module 102 may use software source code 160 that is generated from input computer system 100 I/O devices such as a keyboard 148 (as shown in FIG. 1A) and a mouse 152. The present embodiment may operate in cooperation with the O.S. 111 and the compilation system 108 thereby enabling flexible formation and management of an open service contract 326. It will be appreciated that the present embodiment operates on any multi-purpose computer system 100 and is not limited to the illustration herein. A software developer may create source code 160 typically in a high-level programming language such as “C” or the product marketed under the trademark JAVA.™

Alternatively, the open system module 102 may operate in cooperation with code written to comply with a programming paradigm, such as an interface definition language (IDL). An example of an IDL is CORBA. An IDL typically defines an interface that is used with source code that complies with the IDL. Therefore, the source code 160 may be developed with an IDL and is then translated to a form of source code 160 that operates with the compilation system 108. The open services module 102 may operate in cooperation with any computer-based source code 160, such as a form compatible with an IDL, to flexibly form and manage an open service contract 326 (as shown in FIG. 2).

The computer system 100 may manage the processing of the source code 160 through the O.S. 111. The O.S. 111 may direct the processing of the source code 160 by a compiler optimizer 161 that may generate intermediate code 164 from the source code 160. The intermediate code 164 typically is a list of intermediate-level language instructions 208. Alternatively, the optimizer 161 may generate object code 168 that includes optimization changes that may be dependent on the particular multi-purpose computer system 100 on which the compiler optimizer technology operates.

In the present embodiment the linker 170 may operate on the output of the optimizer 161 which may be object code 168. In order to execute the object code 168 it is combined with one or more object code modules 227 to create combined user process executable code 172 by a process known as linking.

The present embodiment may employ a linker 170 to resolve any undefined computer location references in the object code 168 and to generate executable code 172 capable of executing on an output multi-purpose computer system 100 with I/O devices such as a keyboard 148 and a mouse 152. It will be appreciated that the input computer system 100 and the output computer system 100 may be the same computer system 100 and are not limited to the configuration illustrated.

In the present embodiment the executable code 172 may be formatted to enable a loader 174 to load the executable code 172 into the computer system 100 for execution. The executable code 172 may be any of a variety of known executable files or an executable file of a type to be developed in the future. Examples of such known files are those having an extension of “.exe” operating under a DOS or Windows operating system or an “a.out” file of an O.S. 111 marketed under the trademark UNIX®. It will be appreciated that typically the compilation system 108 may include the optimizer 161, the linker 170, and the loader 174. The optimizer 161 or any other functional component of the compilation system 108 may cooperate with the open services module 102 thereby enabling flexible formation and management of an open service contract 326.

FIG. 1C is a block diagram that illustrates the operation of the open services module 102 that operates in coordination with the emulator 190, such as the product marketed under the trademark JAVA Virtual Machine.™ Source code 160 typically is loaded through an input device and may be stored on the data storage device 140 (as shown in FIG. 1A). A copy of the source code 160 or portions of it, may alternatively be placed by the processor 104 into the memory 106 (as are shown in FIG. 1A) for execution on the computer system 100. The O.S. 111 may operate to associate the source code 160 with the compilation system 108 that may generate code for use by the emulator 190. The open services module 102 may also operate with the compilation system 108 and the O.S. 111 to create an open system contract 326 (as shown in FIG. 2). The compilation system 108 may generate code for use by the emulator 190.

Alternatively, the open system module 102 may operate in cooperation with code written to comply with a programming paradigm, such as an IDL. Therefore, the source code 160 representing the open service 202 (as shown in FIG. 2) may be developed to comply with an IDL that is translated to a form of source code 160 that operates with the compilation system 108 and the emulator 109.

In yet another alternative the open services module 102 may operate with the emulator 190 directly thereby enabling flexible formation and management of an open service contract 326. The emulator 190 may then operate, typically in an iterative manner, to create emulated instructions 193. Typically the emulated instructions 193 are associated with a different computer system 100 than the executing computer system 100.

FIG. 2 illustrates data structures and modules 227 used by the open services module 102 that may be stored in the memory 106. Further, FIG. 2 represents memory-based computer structures that may be embodied in the memory 206 during the execution of the open services module 102. The memory 106 may include the following:

an open services module 102 that forms and manages an open service contract 326;

a citizen tool 404 that will be used interchangeably herein with the terms “citizen” or “party” and that participates in forming, performing, or managing an open service contract 326 and may be a buyer-seller 406, a buying-selling agency 408, or a mediator 410;

electronic business transaction phases 309 that represent life cycle phases that are elements of the process of creating an electronic contract for open services 326;

an offer advertising and discovery phase 311 that is an element of the electronic business transaction phases 309, in which an offer is advertised and potentially discovered;

an offer creation phase 310 that is an element of the electronic business transaction phases 309, in which an offer for an open service 202 is formed from an open service description 304;

a pre-contractual negotiation phase 312 that is an element of the electronic business transaction phases 309, in which negotiations related to refining an open service offer 308 are undertaken;

a contract formation phase 314 that is an element of the electronic business transaction phases 309, in which a contract for open services 202 is formed;

a contract performance phase 316 that is an element of the electronic business transaction phases 309, in which performance pursuant to a contract for open service 326 is undertaken, such as executing the functionality of the open service 202, monitoring the performance and billing associated with the open service 202;

a marketmaker tool 402 that will be used interchangeably herein with the term “marketmaker” 402 that creates an electronic environment of business trust to ensure a party 404 may safely transact an open service 202 and a marketmaker 402 may be a trusted third party;

a buyer-seller tool 406 that will be used interchangeably herein with the term “buyer-seller” 406 that performs the functionality of an open service 202;

a buying-selling agency tool 408 that will be used interchangeably herein with the term “buying-selling agency” 408 that offers economy of scale services for formation of an open service contract 326;

a mediator tool 410 that will be used interchangeably herein with the term “mediator” 410 that enables the creation of an open service offer 308;

an open service 202 that is a service freely offered in a computer-based electronic environment based on trust that performance associated with an open service contract 326 will be monitored and enforced by a trusted third party, such as a marketmaker 402;

an open service offer 308 that is an offer associated with the formation of an open service contract 326 and is negotiable;

an open service description 304 that includes management policies, such as a description of the functionality of the open service 202 and the billing policies associated with the open service 202;

an open service functional description 306 that is included in the open service description 304 and that is a description of the functionality of the open service 202;

an open service commitment 324 that includes signatures of parties and prohibits non-repudiation of the open service contract 326;

an open service contract 326 that is a completed open service commitment 324 and that is created by the contract lifecycle manager 542 and operates as a managed connection that links interactions between open service instances 532 associated with the open service contract 326;

an open service type 303 that enables delivery of an open service instance 532;

a welcoming party 504 that provides authentication and authorization for a citizen 404;

a citizenship registrar 506 that associates various levels of authorization privileges with a citizen 404;

a litigation bureau 508 that provides information about use of an open service 202 by a citizen 404, and manages billing and open service 202 usage information associated with a citizen 404 and submits claims to the marketmaker 402;

a penalty exactor 510 that links the penalty information to the appropriate payment information;

a revenue meter 512 that resolves information required to create charging information associated with an open service contract 326 that may be used for billing;

a contract monitor 514 that resolves information regarding policy requirements that are associated with managing the open service contract 326 and monitors communication associated with performance of an open service contract 326;

a binding manager 522 that binds an open service contract view 552 with an open service instance 532;

an open service type repository 524 that associates open service descriptions 304 with installed open service types 303;

an open service lifecycle manager 530 that manages an open service instance 532, enables creation of open service instances 532 by interaction with the open service type repository 524, and uses information from the open service description 304 associated with an open service type 303 to make deployment decisions for an open service instance 532;

an open service instance 532 that may be represented as a specific result of the execution of the open service type 303 executable file;

a contract lifecycle manager 542 that manages the lifecycle associated with the formation and management of an open service contract 326;

a basic citizenship module 546 that gives instructions to the contract lifecycle manager 542 that include initiating, renewing, or withdrawing an open service contract 326;

a contract view manager 548 that enables management of the open service contract view 552 in the buyer-seller tool 406;

an open service contract view 552 that is the buyer-seller's 406 view of an open service contract 326;

a recommender 562 that provides information from a mediator 410 to a buying-selling agency 408 or a citizen 404;

an agency office 564 that records information about the parties associated with the buying-selling agency 408;

an open service offer de-composer 566 that attempts to decompose an open service offer 308 into sub-offers that may be associated with an open service contract 326;

an open service composer and creator 568 that creates an open service offer 308 and an open service type 303 that may be implemented using work flow technology;

a negotiator 582 that facilitates negotiation related to the open service contract 326;

a bid manager 584 that controls bidding on the open service 202;

a contract former 586 that forms the open service contract 326;

an insurer 588 that provides insurance against risk to citizens 404 with respect to the open service contract 326;

an advertiser 590 that advertises open services 202 via an open service offer 308;

a finder 592 that locates an open service offer 308;

a value 230 that includes instructions 208 and data, such as integer, real, or complex numbers, characters, or pointers that reference values 230;

an address 235 that may be a computer hardware register or a location in the memory 106 (as shown in FIG. 1A);

a module 227 that is a software procedure or function, such as a unit of code that may be independently compiled;

an instruction 208 that may represent a computer address 225 and that may also include variables that are identifiers for values 230;

a compilation system 108 that translates program code into instructions 208 that operate on the computer system 100;

an emulator 190 that substitutes instructions 208 typically associated with a different computer system 100 than the executing computer system 100;

source code 160 that is manipulated by a computer system 100 and that is typically written in a high-level programming language;

intermediate code 164 that is a list of intermediate-level language instructions 208;

object code 168 that includes optimization changes which may be dependent on the particular multi-purpose computer system 100 on which the compilation system 108 operates;

executable code 172 that is capable of executing on a multi-purpose computer system 100;

as well as other data structures and modules 227.

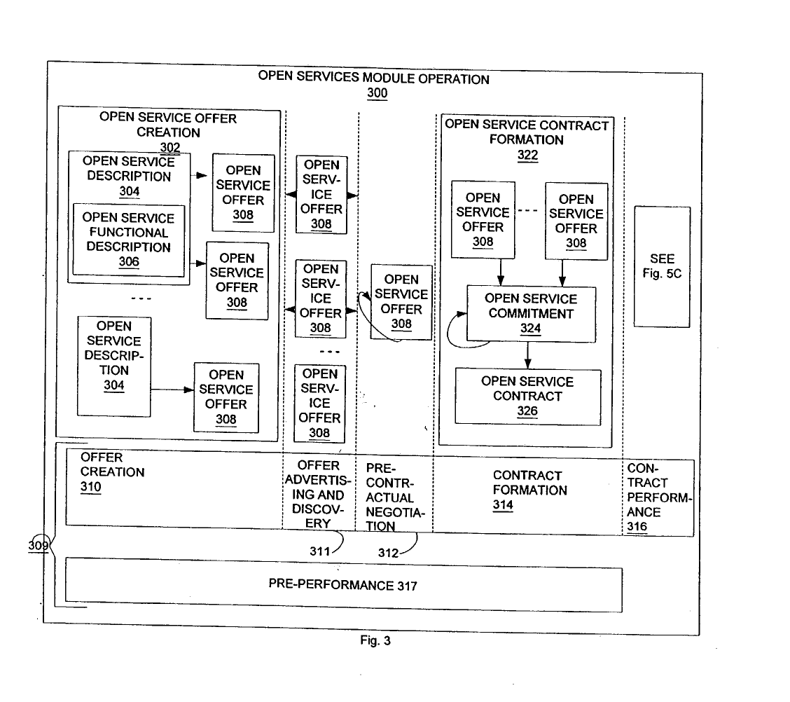

FIG. 3 is a flow diagram and as shown in element 300 illustrates the operation of the open services module 102 throughout the electronic business transaction phases 309. The open services module 102 enables flexible formation and management of an open service contract 326. By novelly introducing electronic business transaction phases 309 to the operation of creating and managing an open service contract 326, the present embodiment enables a distributed computing solution for the exchange of valuable services in which a party 404 (as shown in FIG. 2) may assume a variety of roles. Therefore, the present invention enables formation and management of electronic open service contracts 326 in computer-based environments, such as the internet, that do not rely on client-server configurations.

The reference element 302 illustrates the formation of an open service offer 308 and includes terms and conditions such as management policies associated with the open service 202 (as shown in FIG. 2). The terms and conditions of an open service offer 308 may be represented as a protocol that define functions that manage the formation of the open service offer 308. The term “protocol” as used herein represents the rules determining the formatting and transmission of data.

An open service description 304 is associated with an open service 202 and forms a portion of a description of an open service offer 308. The open service description 304 is created during the development of the open service 202. The open service description 304 is not negotiable and includes management policies, such as a description of the functionality of the open service 202 and the charging information associated with the open service 202. The open service functional description 306 is included in the open service description 304 and is a characterization of the functionality of the open service 202.

During the offer creation phase 310 the open service description 304 is associated with an open service offer 308. The open service description 304 may be constructed by source code 160 (as shown in FIG. 2) that is defined by an IDL. The open service functional description 306 may be compatible with the interface of the IDL. Therefore, the information associated with the open service description 304 and the open service functional description 306 may be represented as a protocol. One open service description 304 may be used to form more than one open service offer 308. An open service offer 308 may include pricing information.

During the offer advertising and discovery phase 311 the creation of the open service offer 308 is enhanced when the open service offer 308 is made available for the purpose of forming an open service contract 326. For instance, an open service offer 308 may be advertised to mediators 410 or to buying-selling agencies 408 (as are shown in FIG. 2). The discovery of an open service offer 308 also occurs during this phase.

During the pre-contractual negotiation phase 312 and by the use of one or more open service descriptions 304, the present embodiment novelly enables the formation of an open service offer 308, which may be negotiated by multiple mediators 410. The mediators 410 may respond to the open service offer 308, may make a counter open service offer 308, or may change the open service offer 308.

The reference element 322 illustrates the formation by the mediator 410 of an open service contract 326 during the contract formation phase 314. The open service commitment 324 contains the signatures of the committed parties. By means of example, the open service commitment 324 may include computer-based digital signatures that ensure accountability of the parties 404 and prohibit open service contract 326 non-repudiation. Validation of the signatures occurs during the contract performance phase 316. Also, an open service commitment 324 may include penalty clauses for failure to perform the open service 202. A party 404 may de-commit from an open service commitment 324 but may incur a penalty for doing so.

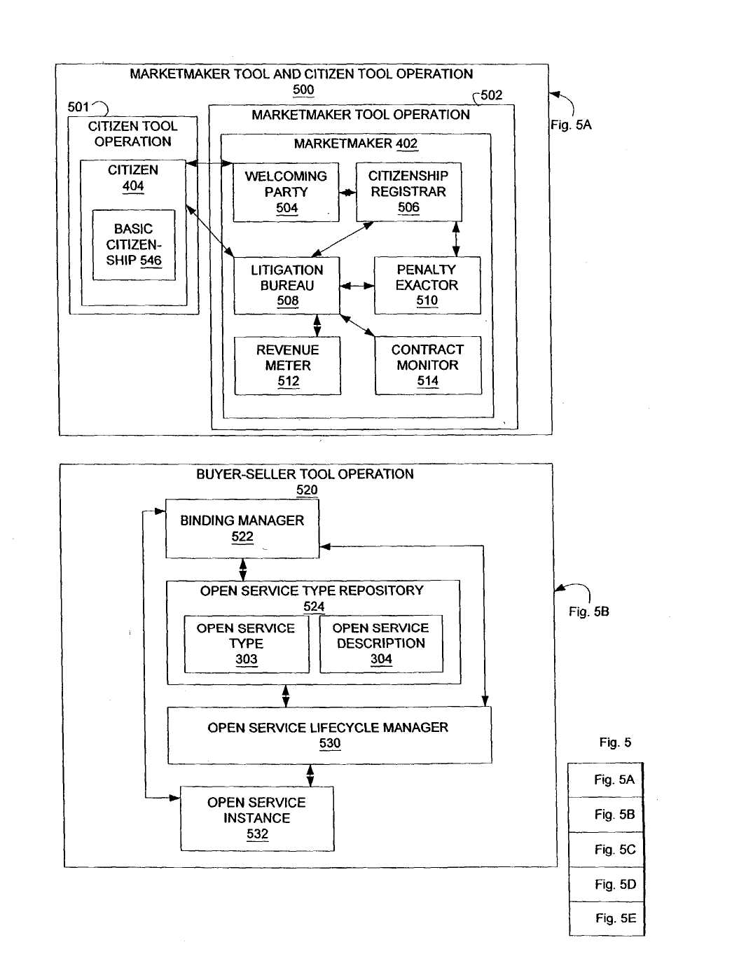

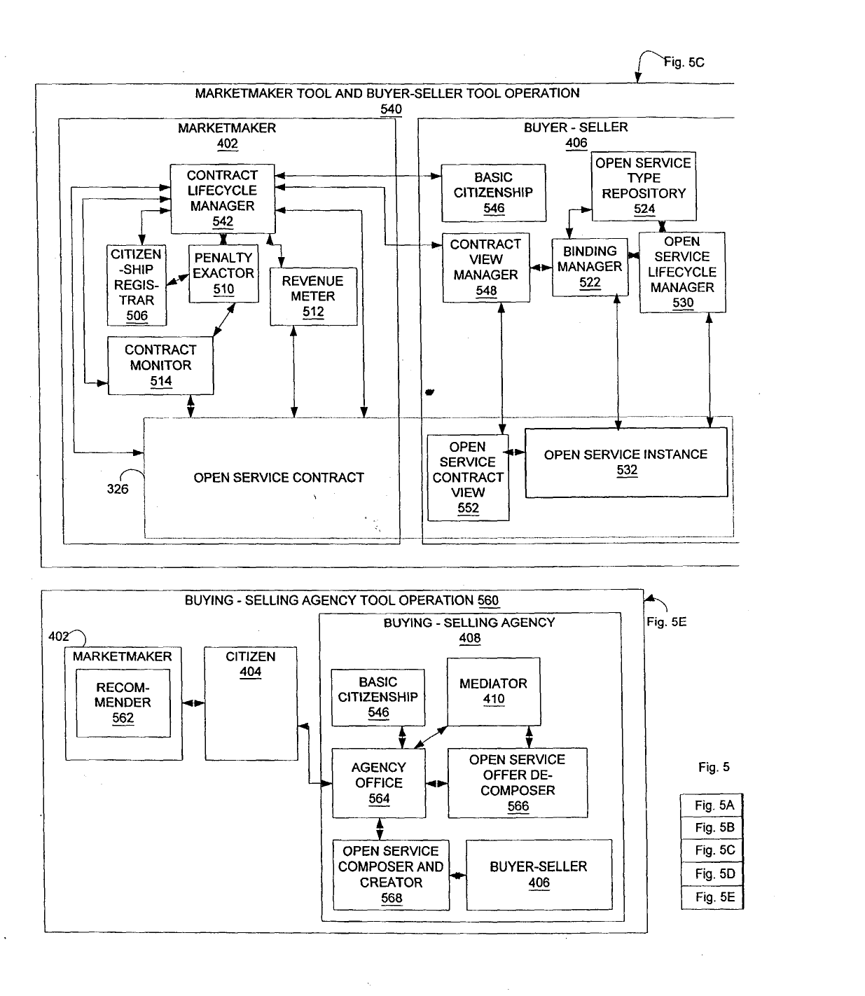

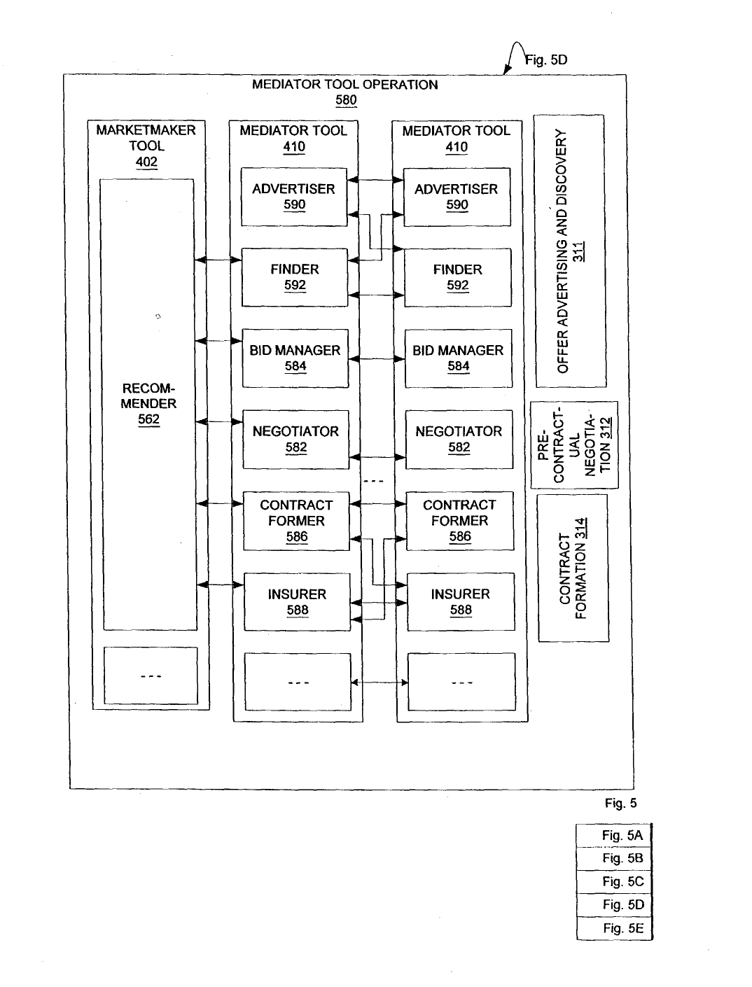

An open service contract 326 is a completed open service commitment 324 that is associated with an open service offer 308. The open service commitment 324 includes signatures from the marketmakers 402 that have authority to enforce the open service contract 326, the buyer-sellers 406 that will perform the open service contract 326, and the mediators 410 that have marked-up the open service contract 326 for payment of mediation services associated with the open service contract 326. The role of the marketmaker 402 is discussed with reference to FIG. 5C. The role of the mediator 410 is discussed with reference to FIG. 5D and by means of example a mediator 410 may provide insurance for an open service contract 326, act as an endorser to commercial paper associated with an open service contract 326, or act as an agent to bring two or more parties 404 together to negotiate an open services offer 308. Thereby a mediator 410 may effectuate the formation of an open service contract 326 while not providing the open services 202 associated with the open service contract 326. The buyer-sellers 406 participate in the contract performance phase 316 that will be discussed with reference to FIG. 5C.

The pre-performance phase 317 includes the offer creation phase 310, the offer advertising and discovery phase 311, the pre-contractual negotiation phase 312, and the contract formation phase 314.

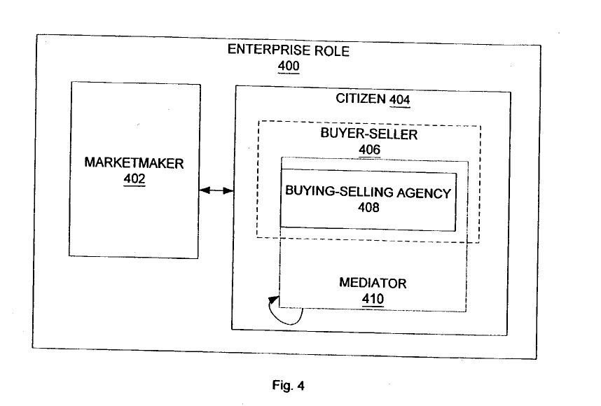

FIG. 4 is a flow diagram that illustrates the enterprise role 400 of the present embodiment and is a high level description of the roles associated with the open service contract 326 (as shown in FIG. 2). The enterprise role 400 includes a marketmaker 402 that enforces the open service contract 326 against threats such as fraud, theft, or force. The marketmaker 402 also communicates with various parties 404 associated with an open service contract 326 such as the buyer-seller 406, the buying-selling agency 408, and the mediator 410 to enable performance of the open service contract 326. The marketmaker 402 novelly operates with a minimal infrastructure that supports trusted electronic open service transactions that are freely offered for the purpose of exchanging open services 202 (as shown in FIG. 2) for value. The role of the marketmaker 402 is further described with reference to FIG. 5A.

The buyer-seller 406 assumes responsibility to perform pursuant to the open service contract 326. A buyer acquires possession, ownership, or rights to the use of services in exchange for value. A seller exchanges property or services for value. In the present embodiment the role of buyer-seller 406 combines the roles of a buyer and a seller and is associated with an open service contract 326. The buyer-seller 406 performs the terms and conditions of the open service contract 326 that define the value to be exchanged for the open service 202 and management policies associated with the exchange. Therefore, the present embodiment manages the performance of an open service contract 326 by association with the buyer-seller 406.

The buyer-seller 406 may operate as a buying-selling agency 408 that offers economy of scale services for formation of an open service contract 326. A buying-selling agency role 408 advantageously operates on an economy of scale to combine open service offers 308 and decompose open service offers 308 that enable prospective parties to access alternatively packaged open service offers 308. By means of example the buying-selling agency 408 may provide information about a plurality of open services 202 to a buyer-seller 406 or to a mediator 410 to expedite the association of a buyer-seller 406 with an open service 202. The buying-selling agency 408 may act as an interface between a plurality of buyer-sellers 406 and the buying-selling agency 408 may retain knowledge of the identify of each buyer-seller 406 without revealing the identity to other buyer-sellers 406. The buying-selling agency 408 also may act for the buyer-seller 406 by performing services such as power of attorney.

The mediator 410 enables the formation of an open service offer 308 by providing functions such as negotiation, managing a bid for open services 202, forming an open service contract 326, and insuring, advertising, and finding buyer-sellers 406. The mediator 410 may interact with other mediators 410 to form an open service offer 308. The mediator 410 will be discussed with reference to FIG. 5D. Further, the mediator 410 may include the buying-selling agency 408 that represents a specific type of mediator 410.

A citizen, or party, 404 represents a user to the computer system 100 (as shown in FIG. 1A) by enabling interaction with the welcoming party 504, registration with the citizenship registrar 506, and access to the litigation bureau 508 for management purposes such as auditing actions of a citizen 404, complaining about failure to perform services, or reporting a security breach (as are shown in FIG. 5A). The buyer-seller 406, the buying-selling agency 408, and the mediator 410 are citizens 404.

FIG. 5A is a flow diagram and element 500 illustrates the marketmaker tool 402 operation and the citizen tool 404 operation. The operation of the citizen tool 404 is shown in element 501. The citizen tool 404 includes a basic citizenship module 546 that enables communication between the citizen 404 and the marketmaker 402. More particularly the basic citizenship module 546 keeps registration code and authentication code, such as digital signatures, associated with the citizen 404 that allow the citizen 404 to access the marketmaker 402.

The marketmaker tool operation as shown in element 502 includes access and auditing functions for an open service 202 (as shown in FIG. 2). More particularly, the access function enables a citizen 404 or a marketmaker 402 to have access to computer-based tools necessary to form an open service contract 326 (as shown in FIG. 2) and the audit function enables inspection and query of information about the use of an open service 202. A trusted third party, such as a marketmaker 402, supports the free market economy infrastructure associated with an open service 202 by enabling computer-based network communication and security, managing levels of authorization privileges associated with a citizen 404, and enforcing performance of an open service contract 326. The marketmaker 402 includes a welcoming party 504, a citizenship registrar 506, a litigation bureau 508, a penalty exactor 510, a revenue meter 512, and a contract monitor 514.

The welcoming party 504 provides authentication and authorization for the citizen 404 thereby enabling a citizen 404 to exercise functions of the open services module 102 (as shown in FIG. 2) such as the those supported by the litigation bureau 508. The welcoming party 504 relies on information from the citizenship registrar 506 to validate the authorization associated with a citizen 404.

The citizenship registrar 506 is used by a new citizen 404 to establish identification for purposes of forming, performing, or managing an open service contract 326. Further, the citizenship registrar 506 associates various levels of authorization privileges with a citizen 404. The authorization privileges may be provided by the litigation bureau 508 and the penalty exactor 510. Also the citizenship registrar 506 may store credentials of a citizen 404 that are used to enable certification of a citizen 404 for third party payment of open services 202.

The litigation bureau 508 provides information about the use of an open service 202 by a citizen 404, manages charging and billing information, manages open service 202 usage information associated with a citizen 404, and submits claims to the marketmaker 402. More particularly, the litigation bureau 508 interacts with the revenue meter 512 to provide charging information related to open service contracts 326 with which the citizen 404 is associated. Charging information is associated with a specific open service contract 326 and billing information may be general policies used with billing code. The litigation bureau 508 also provides information to the contract monitor 514 on QoS associated with a contract. The term “QoS” as used herein represents the quality of service on the internet, or other networks, and by means of example may include measurement of transmission rates and error rates of information over a network.

The litigation bureau 508 also interacts with the penalty exactor 510 to obtain information about penalties associated with the citizen 404. This provides a facility to handle complaints or claims regarding the citizen 404. The litigation bureau 508 may communicate information to the citizen 404.

The contract monitor 514 resolves information regarding policy requirements that are associated with managing the open service contract 326 and monitors communication associated with performance of an open service contract 326. The policy requirements are established during the formation of the open service contract 326 and are associated with the open service contract 326. Further the contract monitor 514 maintains configuration information that will be used to enforce the policy requirements of the open service contract 326. When a breach of the policies associated with the open service contract 326 has occurred the contract monitor 514 communicates with the penalty exactor 510.

The revenue meter 512 resolves information required to create charging information for managing billing information associated with an open service contract 326. The charging requirements are established during the formation of the open service contract 326 and are associated with the open service contract 326. Further, the revenue meter 512 configures mechanisms that will create the billing information associated with the open service contract 326. More particularly the revenue meter 512 manages policies for collection, filtering, and aggregation of charging information associated with an open service contract 326. Also, the revenue meter 512 interfaces with computer-based billing systems.

FIG. 5B is a flow diagram and as shown in element 520 illustrates the operation of the buyer-seller tool 406 during the contract performance phase 316. The open service type repository 524 associates open service descriptions 304 with installed open service types 303 that are used to create open service instances 532. Also, the association of the open service description 304 with the open service type 303 enables the open service description 304 to be extracted and inspected.

Recall that during the pre-contractual negotiation phase 312 (as shown in FIG. 3) open service offers 308 are communicated. Further the open service offer 308 is associated with an open service description 304. Also, a particular view of the open service offer 308 is associated with a particular open service contract view 552 as discussed with reference to FIG. 5C.

The binding manager 522 may be informed of the installation and removal of an open service type 303 by the open service type repository 524. The binding manager 522 may communicate with the open service lifecycle manager 530 directly to create an open service instance 532 that will be bound to the open service contract view 552. The binding manager 522 will be further discussed with reference to FIG. 5C.

An open service instance 532 is executable code 172 (as shown in FIG. 2) generated from the open service type code 303 by the operation of the compilation system 108 or the emulator 190 (as arc shown in FIG. 1A) and the open service lifecycle manager 530. Therefore the open service lifecycle manager 530 enables creation of the open service instance 532 by interaction with the open service type repository 524. Also the open service instance 532 is managed by the open service lifecycle manager 530. An open service instance 53 may be bound to a plurality of open service contracts 326 by the associated open service contract views 552 and is discussed with reference to FIG. 5C.

FIG. 5C is a flow diagram and as shown in element 540 illustrates the operation of the marketmaker tool 402 and the buyer-seller tool 406 during the contract performance phase 316 (as shown in FIG. 3). More particularly, performance of an open service contract 326 first requires initialization of functions associated with an open service contract 326, such as binding an open service instance 532 to an open service contract view 552. Then the parties may operate to perform the obligations set out in the open service contract 326.

The marketmaker 402 creates an electronic environment of business trust by operating to ensure that a party may safely participate in a transaction associated with an open service 202 (as shown in FIG. 2). For example, the marketmaker 402 ensures that parties to an open service contract 326 adhere to policies, such as billing and collection policies, associated with the open service contract 326.

The contract lifecycle manager 542 manages the formation and performance of an open service contract 326 by interacting with the contract view manager 548 to enable an open service contract view 552 that is necessary to create an open service contract 326. The contract lifecycle manager 542 enables management of the open service contract 326 by coordinating information that is under the control of the buyer-seller 406 and information that is under the control of the market maker 402. Further, the contract lifecycle manager 542 takes instructions from a citizen 404 via the basic citizenship module 546 that include initiating, renewing, or withdrawing an open service contract 326.

The contract lifecycle manager 542 may refuse a request to form an open service contract 326. Also, the contract lifecycle manager 542 may limit the authorization of a citizen 404 with respect to an open service contract 326. Recall that the authorization characteristics of a citizen 404 are available via the citizenship registrar 506 and the penalty exactor 510. By means of example a citizen 404 that has frequently breached open service contracts 326 may be prohibited from operating as a party to other open service contracts 326. The contract lifecycle manager 542 also keeps the citizen 404 informed about changes in the status of an open service contract 326 to which the citizen 404 is a participant. For instance, the contract lifecycle manager 542 may notify a citizen 404 that an open service contract 326 is terminated or initiated.

The contract lifecycle manager 542 creates an open service contract 326 and informs the contract monitor 514 of policies related to authorization levels associated with parties 404 to the open service contract 326. Further, the contract lifecycle manager 542 informs the revenue meter 512 of policies associated with the open service contract 326 related to charging parties 404. Thereby the contract lifecycle manager 542 resolves obligations specified in the open service contract 326 and creates associations with parties 404 to the open service contract 326.

The contract lifecycle manager 542 queries the citizenship registrar 506 to verify authorization privileges associated with a citizen 404. Also, the citizenship register communicates information to the contract lifecycle manager 542 about a change in authorization privileges associated with a citizen 404. The contract lifecycle manager 542 may use information from the citizenship register to communicate billing and payment information to the revenue meter 512. For instance the contract lifecycle manager 542 may validate the digital signatures or credit ratings associated with an open service contract 326.

The penalty exactor 510 manages information regarding lack of contract performance or failure to adhere to policies associated with the open service contract 326. By obtaining information from the citizenship registrar 506 the penalty exactor 510 links the penalty information to the appropriate payment information. If the contract monitor 514 determines that a penalty is due or that a citizen 404 has withdrawn from an open service contract 326 this information is communicated to the penalty exactor 510.

The open service contract 326 is created by the contract lifecycle manager 542 and operates as a managed connection that links interactions between open service instances 532 associated with the open service contract 326. Since the open service instances 532 operate during the execution of the open services module 102 the open service contract 326 also operates during the execution of the open services module 102. Also, the open service contract 326 includes at least one open service contract view 552 that is associated with a party 404 to the open service contract 326. When a plurality of parties 404 are associated with an open service contract 326 there are an associated plurality of open service contract views 552, and the open service contract 326 operates to enable communication between the open service contract views 552.

Moving to the buyer-seller 406, the basic citizenship features are communicated by the basic citizenship module 546 to the contract lifecycle manager 542, such as initiation, renewal, or withdrawal of an open service contract 326. Recall that the contract lifecycle manager 542 will inform the citizen 404 of changes associated with the open service contract 326.

The contract view manager 548 creates a view of the open service contract 326 for the buyer-seller 406. Changes to the open service contract 326 are monitored by the contract view manager 548 and transmitted to the open service contract view 552. Further, the contract view manager 548 obtains information about the open service contract 326 from the contract lifecycle manager 542. The contract view manager 548 monitors the status of the open service contract view 552 and communicates changes in the status of the open service contract view 552 to the contract lifecycle manager 542. Also, information from the contract view manager 548 is used by the binding manager 522 to bind an open service instance 532 to an open service contract view 552.

The open service life cycle manager 530 manages the lifecycle phases of the open service 202 such as instantiating, stopping, and performing the open service 202. An open service instance 532 is associated with an open service contract 326 and is managed by the open service lifecycle manager 530. An open service instance 532 executes the functionality of the open service 202 via an interface that is included in the open service contract view 552.

The open service type repository 524 and the open service lifecycle manager 530 are discussed with reference to FIG. 5B.

The open service contract view 552 is the buyer-seller's 406 view of an open service contract 326. The binding manager 522 associates the open service contract view 552 with the open service instance 532 thereby forming an open service contract 326. The open service contract view 552 is associated with a buyer-seller 406 and if there are a plurality of buyer-sellers 406 associated with the open service contract 326 there are also a plurality of associated open service contract views 552. In the present embodiment the open service contract 326 enables communication via messages between the open service contract views 552 and operates by a programming protocol. An open service contract view 552 may be an application programming interface (API).

The binding manager 522 manages the binding association between an open service contract view 552 and an open service instance 532. The binding manager 522 obtains information from the contract view manger 548 and the open service type repository 524.

FIG. 5D is a flow diagram and as shown in element 580 illustrates the mediator tool 410 operation. The marketmaker 402 operates as a recommender 562 that provides information from a mediator 410 to a buying-selling agency 408 or a citizen 404 (as are shown in FIG. 2). The recommender 562 enables the marketmaker 402 to supply a mediator 410 with information associated with an open service contract 326 (as shown in FIG. 2) about negotiation, bid management, contract formation, insurance, advertisement, and locating an open service contract 326. The marketmaker 402 is discussed with reference to FIG. 5A.

The mediator 410 provides services that enable the creation of an open service contract 326. The mediator 410 may communicate with other mediators 410 to enable the formation of an open service contract 326.

The mediator 410 may act as an advertiser 590 for concerned parties 404 or open services 202 (as shown in FIG. 2). The mediator 410 may also act as a finder 592 to locate an open service offer 308 (as shown in FIG. 2) or to find parties 404 that may wish to form an open service contract 326. An advertiser 590 associated with one mediator 410 may communicate with a finder 592 or an advertiser 590 associated with another mediator 410. A finder 592 associated with one mediator 410 may communicate with a finder 592 or an advertiser 590 associated with another mediator 410. The mediator 410 may also operate to control bidding on the open services 202 thereby acting as a bid manager 584. A bid manager 584 associated with one mediator 410 may communicate with a bid manager 584 associated with another mediator 410. The advertiser 590, finder 592, and bid manager 584 operations occur during the offer advertising and discovery phase 311 that is described with reference to FIG. 3.

The mediator 410 may facilitate negotiation related to the open service contract 326 thereby acting as a negotiator 582. A negotiator 582 associated with one mediator 410 may communicate with a negotiator 582 associated with another mediator 410. The negotiator 582 operation occurs during the pre-contractual negotiation phase 312 that is described with reference to FIG. 3.

Automated negotiation is the operation of using computer-based tools to negotiate services in exchange for valuable consideration. An example of automated negotiation is Universal Product Codes used in point of sale operations to uniquely identify a particular product. The mediator 410 may provide automated negotiation.

The mediator 410 may operate to form the open service contract 326 thereby acting as a contract former 586. Also, the mediator 410 may provide insurance against risk to concerned parties with respect to the open service contract 326 and thereby act as an insurer 588. A contract former 586 associated with one mediator 410 may communicate with a contract former 586 or an insurer 588 associated with another mediator 410. An insurer 588 associated with one mediator 410 may communicate with an insurer 588 or a contract former 586 associated with another mediator 410. The insurer 588 and the contract former 586 operations occur during the contract formation phase 314 that is described with reference to FIG. 3.

The services of a mediator 410 described herein are representative and not intended to limit the range of services that a mediator 410 may provide with respect to an open service contract 326.

The mediator 410 may mark-up the open service contract 326 to extract payment for services. For instance, a mediator 410 may increase the value associated with each open service instance 532 associated with an open service contract 326 and extract the increase as payment for mediation services. The mark-up may be calculated by any well known means including a fixed percentage based on location of sale or customer type.

FIG. 5E is a flow diagram and as shown in element 560 illustrates the buying-selling agency 408 operation. The marketmaker 402 may operate as a recommender 562 to a citizen 404 thereby locating a buying-selling agency 408. The buying-selling agency 408 provides economy of scale services that enable parties to form an open service contract 326 more efficiently. For example the buying-selling agency 408 combines open service offers 308 and decomposes open service offers 308 to enable prospective parties 404 to access alternatively packaged new open service offers 308. The open service contract 326, the open service offer 308, and parties 404 are described with reference to FIG. 2.

The agency office 564 keeps records related to the parties associated with the open service contract 326. For instance a citizen 404 can communicate with the agency office 564 by submitting for sale an open service type 303 (as shown in FIG. 2). The agency office 564 may communicate with the mediator 410 that may bid on or advertise the open service type 303. When the mediator 410 receives an open service offer 308 the mediator 410 decides if the open service offer 308 may be satisfied. The open service offer de-composer 566 may attempt to decompose the open service offer 308 for purposes such as ascertaining if a sub-offer of an open service 202 (as shown in FIG. 2) may be satisfied from the records that are managed by the agency office 564. The agency office 564 may communicate to the mediator 410 that advertisement of the open service type 303 is still necessary if records managed by the agency office 564 do not include an appropriate open service offer 308. The term “sub-offer” herein refers to an offer with limited functionality.

When sufficient open service offers 308 have been collected the open service composer and creator 568 may compose or create a new open service offer 308. The open service composer and creator 568 may also create an open service type 303 that may be installed in the open service type repository 524 thereby enabling an open service contract view 552 to be bound to an open service instance 532.

The operation of the open service offer de-composer 566 is difficult and may require a logic analysis machine, such as a product marketed under the trademark PROLOG ENGINE. The open service composer and creator 568 may create an open service offer 308 and open service type 303 by implementing work flow technology. Work flow process technology makes routing decisions based on the content of the message and the previous state of the information in the message.

The basic citizenship module 546 of the buying-selling agency 408 manages operations required by a citizen 404, such as initiation, renewal, or withdrawal of an open service contract 326.

The mediator 410 is an element of the buying-selling agency 408 and is described with reference to FIG. 5D. The buyer-seller 406 is another element of the buying-selling agency 408 and is described with reference to FIG. 5B.

The foregoing description, for purposes of explanation, used specific nomenclature to provide a thorough understanding of the invention. However, it will be apparent to one skilled in the art that the specific details are not required in order to practice the invention. In other instances, well known devices are shown in block diagram form in order to avoid unnecessary distraction from the underlying invention. The flow charts of the present invention show the architecture, functionality, and operation of an implementation of the present embodiment. In this regard, each block represents a module, segment, or portion of code, which comprises one or more executable instructions for implementing the specified logical function(s). It should also be noted that in some alternative implementations, the functions noted in the blocks may occur out of the order noted in the figures, or for example, may in fact be executed substantially concurrently or in the reverse order, depending upon the functionality involved.

Thus, the foregoing descriptions of specific embodiments of the open services module are presented for purposes of illustration and description. They are not intended to be exhaustive or to limit the invention to the precise forms disclosed, many modifications and variations are possible in view of the above teachings. Those skilled in the art will recognize that changes may be made in form and detail without departing from the scope of the invention. The invention is limited only by the claims.

What is claimed is:

1. A method in a computer system for creating and managing an open service contract, said method comprising:
describing an open service;
describing charging information for said open service;
creating at least one open service offer from said described open service and said described charging information;
discovering said open service offer;
associating an open service commitment with said open service offer; and
creating said open service contract from said open service offer and said associated open service commitment.

2. The method as set forth in claim 1, further comprising: performing said open service contract by creating an open service instance that executes on said computer system.

3. The method as set forth in claim 1 further comprising: enforcing said open service contract by managing access to said open service contract.

4. The method as set forth in claim 1 further comprising: enforcing said open service contract by managing auditing of said described charging information for said open service.

5. The method as set forth in claim 1 further comprising: creating said open service contract by advertising said open service offer.

6. The method as set forth in claim 5 further comprising: decomposing said open service offer thereby enabling effective advertising of said open service offer.

7. The method as set forth in claim 5 further comprising: when at least two said open service offers are created combining said at least two open service offers thereby creating a new said open service offer that enables effective advertising of said new open service offer.

8. The method as set forth in claim 1 further comprising: negotiating for said open service offer thereby enabling creation of said open service contract.

9. A computer system for creating and managing an open service contract comprising:
a description of an open service;
a description of charging information for said open service;
at least one open service offer that is created from said description of said open service and said description of said charging information for said open service;
an open service commitment that is associated with said open service offer; and
said open service contract that is created from said open service offer and said associated open service commitment.

10. The computer system as set forth in claim 9 further comprising: an open service instance that executes on said computer system.

11. The computer system as set forth in claim 9 further comprising: when at least two said open service offers are created, a new said open service offer that is the combination of said at least two open service offers and that enables effective advertising of said new open service offer.

12. The computer system as set forth in claim 9 further comprising: a decomposed said open service offer that enables effective advertising of said decomposed said open service offer.

13. A computer system having a marketmaker tool for accessing and auditing an open service contract and a citizen, said marketmaker tool comprising:
a welcoming party that authenticates and authorizes formation of said open service contract;
a citizenship registrar that identifies a said citizen that is authorized to form said open service contract;
a litigation bureau that manages charging information associated with said open service contract;
a penalty extractor that links penalty data to said charging information;
a revenue meter that resolves said charging information associated with said open service contract;
a contract monitor that monitors communication associated with said open service contract; and
a contract lifecycle manager that manages communication associated with managing the open service contract.

14. A computer system having a buyer-seller tool for performing an open service contract, an open service contract view, and an open service instance, said buyer-seller tool comprising:
a binding manager that associates said open service contract view with said open service instance;
an open service lifecycle manager that manages said open service instance;
a contract view manager that enables said open service contract view thereby creating and managing said open service contract; and
a basic citizenship module that instructs said contract lifecycle manager to initiate, renew, or withdraw said open service contract.

15. A computer system having a buying-selling agency tool for providing economy of scale services associated with at least one open service offer to create an open service contract, and a citizen, said buying-selling agency tool comprising: an agency office that maintains records associated with said citizen and said open service contract.

16. The computer system as set forth in claim 15 further comprising: an open service composer and creator that creates a new said open service offer by combining at least two said open service offers thereby providing economy of scale services.

17. The computer system as set forth in claim 15 further comprising: an offer decomposer that creates a new said open service offer by decomposing at least one said open service offer thereby providing economy of scale services.

18. A computer system having a mediator tool for negotiating an open service contract, a citizen that is associated with said open service contract, an open service, and an open service offer, said mediator tool comprising:
describing an open service;
describing charging information for said open service;
creating at least one open service offer from said described open service and said described charging information;
discovering said open service offer;
associating an open service commitment with said open service offer; and
creating said open service contract from said open service offer and said associated open service commitment.

19. A computer-readable medium containing instructions for causing a computer system to perform method acts to create and manage an open service contract, said method acts comprising:
describing an open service;
describing charging information for said open service;
creating at least one open service offer from said described open service and said described charging information;
discovering said open service offer;
associating an open service commitment with said open service offer; and
creating said open service contract from said open service offer and said associated open service commitment.

20. The computer-readable medium as set forth in claim 19 wherein said method acts further comprising: performing said open service contract by creating an open service instance that executes on said computer system.

21. The computer-readable medium as set forth in claim 19 wherein said method acts further comprising: enforcing said open service contract by managing access to said open service contract.

22. The computer-readable medium as set forth in claim 19 wherein said method acts further comprising: enforcing said open service contract by managing auditing of said described charging information for said open service.

23. The computer-readable medium as set forth in claim 19 wherein said method acts further comprising: creating said open service contract by advertising said open service offer.

24. The computer-readable medium as set forth in claim 23 wherein said method acts further comprising: decomposing said open service offer thereby enabling effective advertising of said open service offer.

25. The computer-readable medium as set forth in claim 23 wherein said method acts further comprising: when at least two said open service offers are created combining said at least two open service offers thereby creating a new open service offer that enables effective advertising of said new open service offer.

26. The computer-readable medium as set forth in claim 19 wherein said method acts further comprising: negotiating for said open service offer thereby enabling creation of said open service contract.
